(19) United States
(12) Patent Application Publication
(10) Pub. No.: US 2004/0042215 A1
(43) Pub. Date: Mar. 4, 2004

(54) Modeling lamp

(76) Inventor: Simon Juan, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/233,654

(22) Filed: Sep. 4, 2002

(51) Int. Cl. B60Q 3/04

(52) U.S. Cl. 362/362

(57) ABSTRACT

A modeling lamp including a casing, the casing has a modeling frame and a meshed device, the meshed device formed on the modeling frame which a plurality of fasteners on. The lighter can be fastened by the fasteners or directly fixed on the meshed device. The casing has a series of model connecting to the meshed device for scatting the light. The light from modeling lamp of present invention is soft and comfortable especially being essential to festival or romantic day. Further, the meshed device can be colored or added patterns for light to outline the feature of lamp in some special situation.

### BACKGROUND OF THE INVENTION

1. Field of the Invention

The present invention relates to a modeling lamp, and more particularly, to the modeling lamp having a meshed device, the meshed device has many kinds of patterns being able to shield and scatter a part of light to make light softer for decreasing the harsh light to hurt eye and pleasing to the eye.

2. Description of Related Art

Lamp is one of requisites of life. The usage and application of lamp are developed and researched, like shapes, materials, and colors etc. The lamp also can be stand or hang up or lie on for illuminating or decorating like in Christmas, decorating Christmas tree or in ordinarily day, putting animal-light outside for shining and funny. The lamp put inside is more usefully, like door light or floor light. Generally, on the market, the modeling of lamp look like people, animals or the appearance of carton for curtain light. As the living standard raising, how to adorn with lamp to the life is difficulties.

In generally, lamp connecting to ornament shall exposure light on the rack, cause the lamp has low power, so the lamp can not show the modeling, and the exposure light only generate single light spot. As above described lamp, generate the light is irritated and boring.

The value of modeling lamp must be changeable and abound with modeling. By its decoration, let our life full of lovely and interesting. However, the traditional modeling lamp only depend on position of lamp arrangement for modeling. Neither cannot perform the visual feelings what we want to express, nor let people bored with it due to the single spot lamp is dull and harsh to the eye.

As above described, the present invention provide a modeling lamp to improve the tone of light for preventing the harsh light to hurt eye, to tone down the light, and further, to enrich life, it is also the lamp user waiting for. The modeling lamp is improved base on the experience at marking, developing and researching of inventor for resolving the problems as above described.

### SUMMARY OF THE INVENTION

An object of the present invention is to provide a modeling lamp to tone down the harsh light and to decrease the light to hurt eye. The modeling lamp also has variable model to change the colors or put in appearances for adapting around.

Another objective of the present invention is to provide a modeling light have changeable model, as the model replace the light appeared variable

In order to achieve the above objectives, the present invention provides a modeling lamp including a casing, the casing has a modeling frame and a meshed device, the meshed device formed on the modeling frame which a plurality of fasteners on. The lighter can be fastened by the fasteners or fix on the meshed device directly. The casing has a series of model connecting to the meshed device for scatting the light. The light from modeling lamp of present invention is soft and comfortable especially being essential to festival or romantic day. Further, the meshed device can be color or add patterns for light to outline the feature of lamp in some special situation.

The present invention can be fully understood by reading the following detailed description of the preferred embodiments, with reference made to the accompanying drawings.

### BRIEF DESCRIPTION OF DRAWINGS

FIG. 1 is a schematic three-dimensional view of an embodiment of the present invention;

FIG. 2 is a schematic back view of an embodiment of the present invention;

FIG. 2 is a schematic sectional view of an embodiment of the present invention;

FIG. 4 is a schematic three-dimensional view of another embodiment of the present invention;

FIG. 5 is a schematic sectional view of another embodiment of the present invention;

### DETAILED DESCRIPTION OF PREFERRED EMBODIMENT

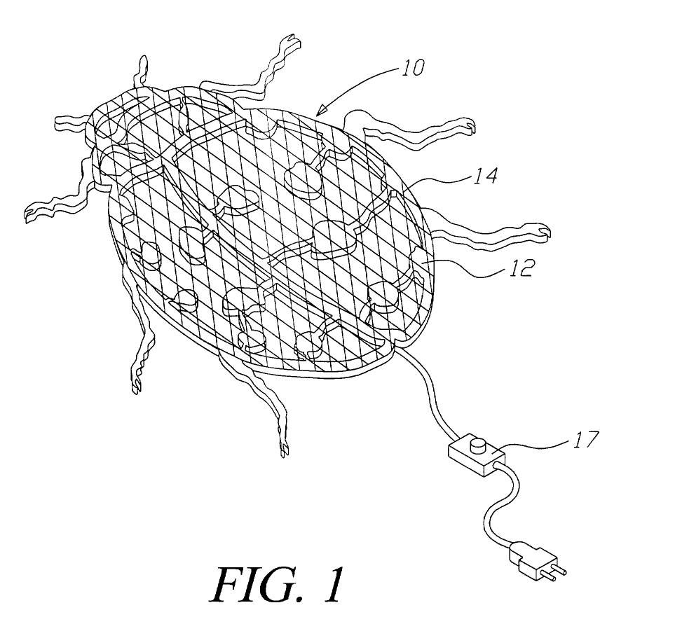

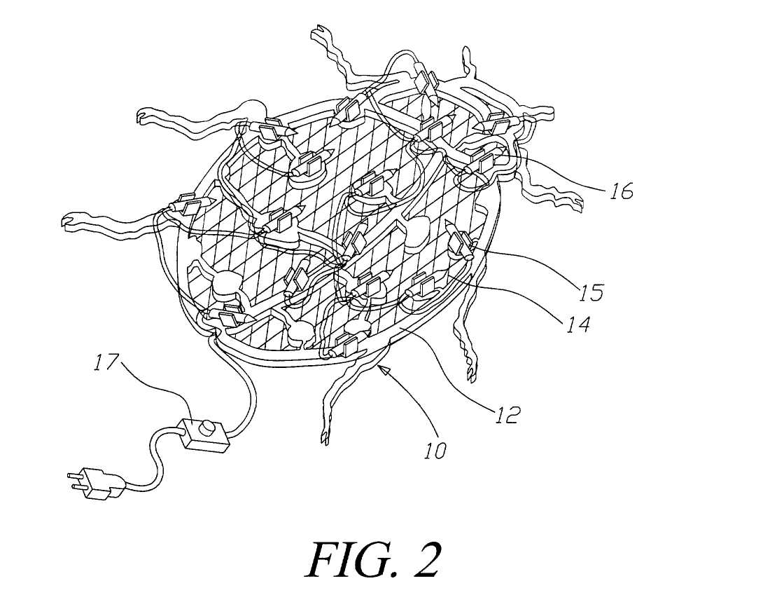

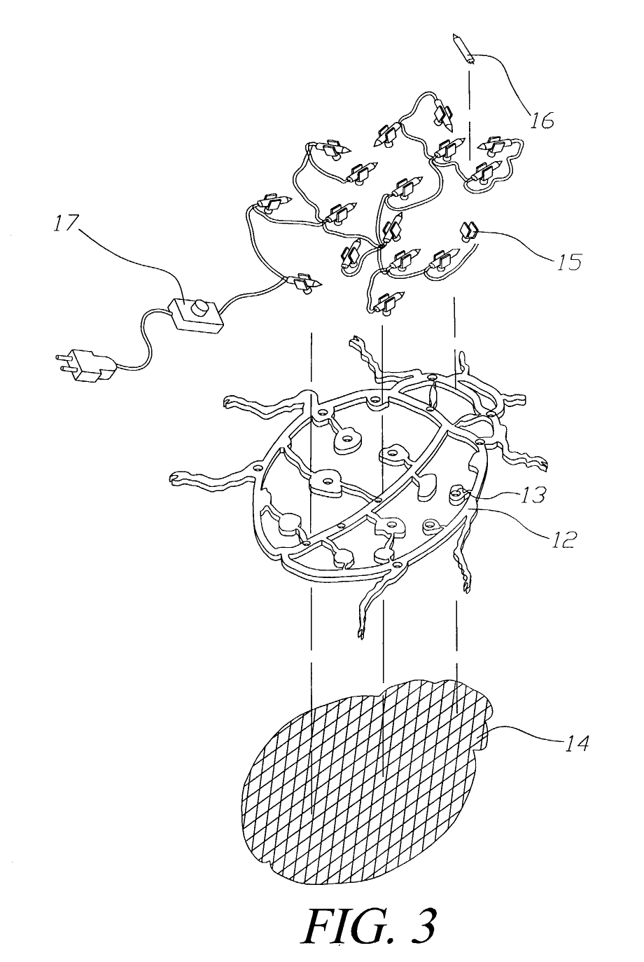

As shown in FIG. 1, FIG. 2 and FIG. 3 the modeling lamp of present invention includes a casing 10, the casing 10 has a modeling frame 12 and a meshed device 14, the modeling frame 12 and the meshed device 14 can be form in one, or the meshed device 14 adhere to or buckle up the modeling frame 12, then formed on the modeling frame 12. The meshed device 14 can be made of any kind of material, means for light to pass through along the weaving of fabric and scatter the light, like weaving clothes, plastic, or metal which can be pervious to light. The modeling frame 12 has a plurality of apertures 13 which has a plurality of fasteners 15 on. The fasteners 15 fasten the lighter 16, adhere to the meshed device 14. The lighter 16 has a controller 17 to control the light shine. The light is changed by different design casing 10, as the different design casing 10 show the meshed device 14 with different colors for pleasure to the eye.

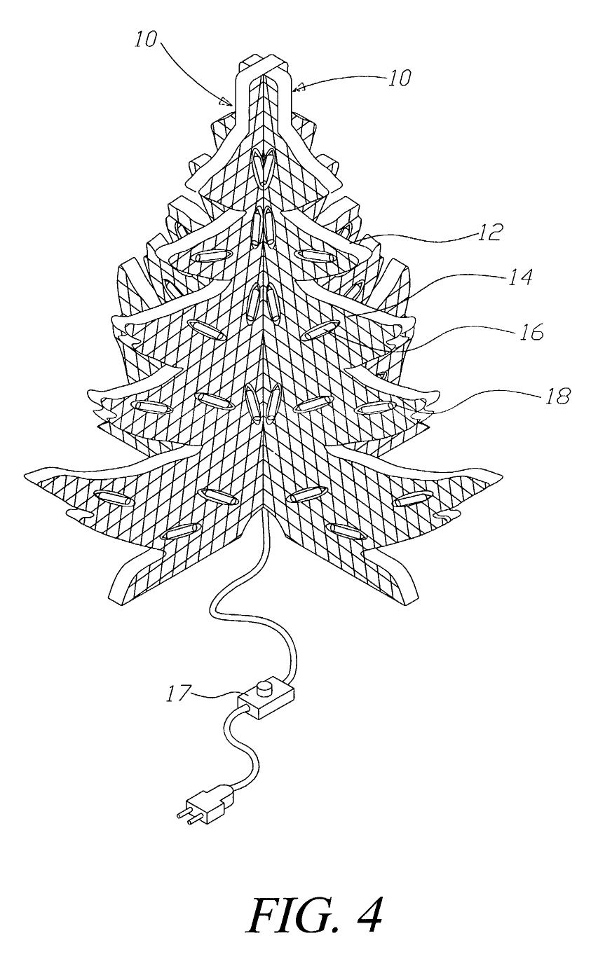

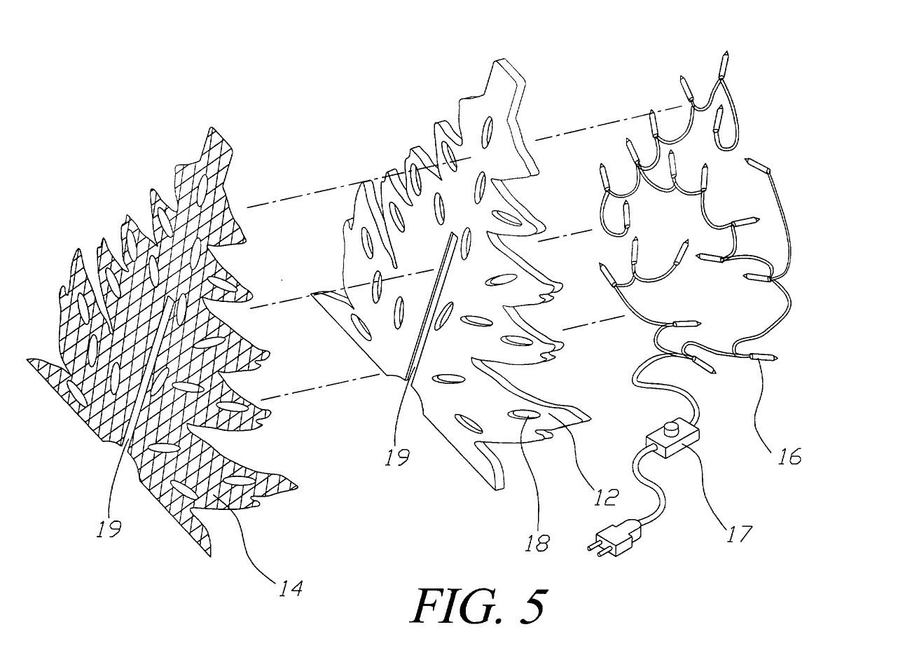

Reference to FIG. 4 and FIG. 5 is schematic three dimension and sectional view of another embodiment of present invention. The casing 10 comprising a modeling frame 12 and a meshed device 14, the modeling frame 12 and the meshed device 14 are formed in one. The meshed device 14 also can adhere to the modeling frame 12, or buckle the meshed device 14. Further, the casing 10 includes a plurality of hole 18 holding a lighter 16. The lighter 16 has a controller 17 to control the light shining. Further, the casing 10 has a cave 19 connect to casing 10 for combining different model, as shows in FIG. 5 achievement of a Christmas tree.

Summing up the aforementioned, the modeling lamp has a casing 10 full of variety to connect a lighter 16, the lighter 16 has a controller 17 to control the light various shin. The light pass through the meshed device 14 can be scatter, especially the meshed device 14 be design or color, the light is softer and not harsh.

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structure are not shown in detail in order to avoid unnecessary obscurity of the present invention.

What is claimed is:

1. A modeling lamp, comprising:
a casing;
a modeling frame;
a meshed device, installed on the modeling frame; and
a plurality of lighters installed on the casing.

2. The modeling lamp of claim 1, wherein the casing and modeling frame are formed in one.

3. The modeling lamp of claim 1, wherein the meshed device adheres to the modeling frame.

4. The modeling lamp of claim 1, wherein the meshed device is made of transparent fabric.

5. The modeling lamp of claim 1, wherein the meshed device is made of plastic by weaving.

6. The modeling lamp of claim 1, wherein the lighter adheres to the meshed device.

7. The modeling lamp of claim 1, wherein the meshed device has a plurality of fasteners for installing the lighter.

8. The modeling lamp of claim 1, wherein the lighter adheres to modeling frame.

9. The modeling lamp of claim 1, wherein the modeling frame has a plurality of fasteners for installing the lighter.

10. The modeling lamp of claim 1, wherein the modeling frame is bundled by a net between the meshed device.

11. The modeling lamp of claim 1, wherein the casing has a cave for buckling up one by one.

12. The modeling lamp of claim 1, wherein the lighter connects to a controller for controlling the lighter to change the light shining.

13. A modeling lamp, comprising:
a casing with a plurality of holes including a modeling frame and a meshed device on the modeling frame; and
a plurality of lighters installed on the holes.

14. The modeling lamp of claim 13, wherein the modeling frame and meshed device are formed in one.

15. The modeling lamp of claim 13, wherein the meshed device adheres to modeling frame.

16. The modeling lamp of claim 13, wherein the meshed device is made of transparent fabric.

17. The modeling lamp of claim 13, wherein the meshed device is made of plastic by weaving.

18. The modeling lamp of claim 13, wherein the modeling frame is bundled by a net between the meshed device.

19. The modeling lamp of claim 13, wherein the casing has a cave for buckling up one by one.

20. The modeling lamp of claim 13, wherein the lighter connect to a controller for controlling the lighter to change the light shining.
